(19) United States
(12) Patent Application Publication
(10) Pub. No.: US 2015/0360437 A1
(43) Pub. Date: Dec. 17, 2015

(54) Structure of Metal Sheet of Autobody and Manufacturing Method Thereof

(71) Applicant: SHANZHEN ZHANG, SHANGHAI (CN)

(72) Inventor: SHANZHEN ZHANG, SHANGHAI (CN)

(21) Appl. No.: 14/593,566

(22) Filed: Jan. 9, 2015

(30) Foreign Application Priority Data
Jun. 16, 2014 (CN) 2014102682698

(51) Int. Cl. B32B 3/26; B32B 27/20; B32B 15/08

(52) U.S. Cl. CPC B32B 3/263; B32B 15/08; B32B 27/20; B32B 2605/08; B32B 2307/102; B32B 2307/56; B32B 2307/304

(57) ABSTRACT

A structure of metal sheet of autobody and its manufacturing method, by a punching machine, a plurality of hexagonal grooves on a metal sheet are uniformity punched, and then with an injection machine, an injection molding of high polymer material for the hexagonal grooves and the metal sheet surface by an inserted injection molding method are performed. The hexagonal grooves have a certain depth, that equivalents to add stiffeners on the metal sheet surface, so as to achieve the same mechanical effect of a thinner metal sheet with that of an original thick metal, thereby enabling to meet the thickness requirement of metal sheet, and meanwhile, decreasing the usage amount of raw material and the whole weight; moreover, high polymer material is adopted in the present invention, to assure the mechanical property of the metal sheet; when crashed, the autobody is capable to effectively play the role of absorbing and dispersing impact force, to protect the members inside to the greatest extent.

### BACKGROUND OF THE PRESENT INVENTION

1. Field of Invention

The present invention relates to a field of automobile manufacturing, particularly relates to a structure of metal sheet of autobody and its manufacturing method.

2. Description of Related Arts

With the improvement of life quality, there appears more and more personal cars, but has not achieve popularization yet, while the major factor for restricting the popularization of cars is price of car. The price of a car is determined according to the production cost of the car, which includes material cost and human cost, etc. With regard to the material cost, in traditional view, the thicker the steel plate is, the stronger the car is. As a result, in order to ensure security, a block of galvanized steel sheet is adopted for the whole autobody, with an average thickness of 0.7˜2 mm. It not only increases cost, but also makes the autobody very heavy. With the improvement of technology, modern automobile manufacturing has been out of the misunderstanding that the thicker the steel plate is, the stronger the car is, and technical staff has concluded from a viewpoint of mechanics: hardness or softness of steel sheet of an autobody shall be determined by various force conditions, so that when crashed, different parts of the autobody play the role of absorbing and dispersing energy, to weaken impact force as possible, thereby achieving the object that protects the driver and other members inside to the greatest extent. Therefore, it is a technical problem urgently to be solved that develops a steel sheet providing the strength of autobody, under the precondition of cost-effective.

### SUMMARY OF THE PRESENT INVENTION

The technical problem to be solved of the present invention is to provide a structure of metal sheet of autobody with lighter weight and lower cost, so as to overcome the above advantage in the prior art.

In order to solve the above technical problem, the present invention adopts the following technical solution: a structure of metal sheet of autobody, the metal sheet is uniformly provided with a plurality of hexagonal grooves, in the hexagonal grooves and on the side of metal sheet surface having the hexagonal grooves are all provided with high polymer material.

Preferably, depth of the hexagonal groove is 0.5˜3 mm.

Preferably, thickness of the high polymer material of the metal sheet surface is 0.5˜3 mm.

Preferably, distance between two opposite sides of the hexagonal groove is 3˜25 mm.

Preferably, one side of the metal sheet having no high polymer material is provided with felt or other fillers featuring a cushioning effect.

Preferably, the high polymer material is PC, ABS, PMMA or PBT material.

The present invention further provides a method for preparing the structure of metal sheet of autobody, adopting the following technical solution that: a manufacturing method for a structure of metal sheet of autobody, includes the following steps:

First, cleaning the metal sheet to be manufactured, and removing impurities on a metal sheet surface;

Second, placing the metal sheet on a punching machine, and punching hexagonal grooves on the metal sheet by the punching machine;

Third, detaching the metal sheet from the punching machine, placing the metal sheet on an injection machine, and performing an injection molding of high polymer material for the hexagonal grooves and the metal sheet surface by an inserted injection molding method.

Preferably, after the third step, perform spray-painting or prepare dermatoglyph on the side of the metal sheet having high polymer material of injection molding.

From the above, the structure of metal sheet of autobody and its manufacturing method of the present invention, have the following beneficial effects:

1. The metal sheet of autobody of the present invention is provided with a plurality of hexagonal grooves, which helps to save the usage of raw material, and to reduce the whole weight under the precondition of constant stress. Also, in the present invention, an injection molding of high polymer material is performed on the metal sheet surface, thereby effectively ensuring good mechanical property of the metal sheet of the autobody by the high polymer material, and satisfying the requirement of crash and shock that when crashed, the autobody is capable to play the role of absorbing and dispersing energy, to weaken impact force as possible, so as to achieve the object that protects the driver and other members inside to the greatest extent. Therefore, the present invention effectively overcomes the disadvantages of autobody with heavy weight and high cost, and brings great benefits for the modern automobile manufacturing.

2. By a punching machine, a plurality of hexagonal grooves on a metal sheet are uniformity punched, and then with an injection machine, an injection molding of high polymer material for the hexagonal grooves and the metal sheet surface by an inserted injection molding method are performed. The hexagonal grooves have a certain depth, that equivalents to add stiffeners on the metal sheet surface, so as to achieve the same mechanical effect of a thinner metal sheet with that of an original thick metal, thereby enabling to meet the thickness requirement of metal sheet, and meanwhile, decreasing the usage amount of raw material and the whole weight; moreover, high polymer material is adopted in the present invention, to assure the mechanical property of the metal sheet; when crashed, the autobody is capable to effectively play the role of absorbing and dispersing impact force, to protect the members inside to the greatest extent.

### BRIEF DESCRIPTION OF THE DRAWINGS

FIG. 1 is a structural diagram of the present invention.

FIG. 2 is a structural section diagram of the present invention.

In figures:

1 metal sheet

11 hexagonal groove

2 high polymer material

### DETAILED DESCRIPTION OF THE PREFERRED EMBODIMENTS

The structure, the scale, the size and the like shown in the drawings attached in this specification are all simply used to match with the content exposed by the specification for the skilled in the art understanding and reading, but not used to limit qualifications when the invention may be implemented, thus any modification of structure, alteration of proportional relation, or modulation of size without technical essential meanings shall be fall into the covered scope by the disclosed technical solution of the invention, with no effect to the generated function and achieved objects of the present invention. Meanwhile, terms such as “up”, “down”, “left”, “right” and the like cited in this specification are also simply for clearness of the description but not used to limit the scope implemented by the invention. The change or the adjustment of the relative relation should also be seen as the scope of the invention when there is no substantial alteration in the technical content.

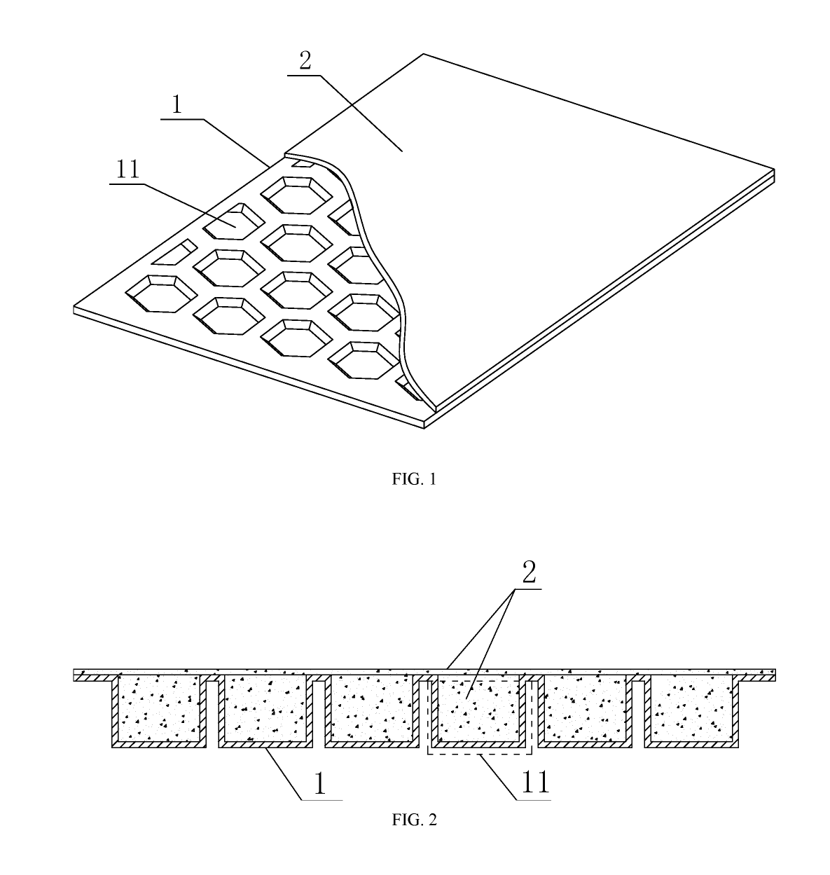

FIGS. 1 and 2 are shown to a structure of metal sheet of autobody of the invention, the metal sheet 1 is uniformly provided with a plurality of hexagonal grooves 11, in the hexagonal grooves 11 and on the side of metal sheet surface having the hexagonal grooves 11 are all provided with high polymer material 2. Further, one side of the metal sheet having no high polymer material is provided with felt or other fillers featuring cushioning, soundproof, insulating effects. Moreover, the hexagonal groove 11 of the present invention is of regular hexagon.

In the embodiment, in order to assure wall thickness of the metal sheet 1 and the hexagonal grooves 11, and meanwhile to meet the requirements of thickness and mechanical property, depth of the hexagonal groove is 0.5˜3 mm.

In the embodiment, in order to meet the requirements of rigidity and other mechanical properties for autobody after the autobody is prepared, thickness of the high polymer material 2 of the metal sheet surface is 0.5˜3 mm.

In the embodiment, distance between two opposite sides of the hexagonal groove 11 is 3˜25 mm.

In order to assure the wall thickness of the metal sheet 1 and the hexagonal grooves 11, distance between two adjacent hexagonal grooves 11 is 2˜10 mm.

The above data are obtained through a larger number of experiments by inventors.

A manufacturing method for a structure of metal sheet of autobody of the present invention includes the following steps:

Firstly, cleaning the metal sheet 1 to be manufactured, and removing impurities on a surface of the metal sheet 1; then placing the metal sheet 1 on a punching machine, installing a mould that meets the dimensional requirement for hexagonal grooves 11 onto the punching machine, and punching hexagonal grooves 11 on the metal sheet 1 by the punching machine; after punching the hexagonal grooves 11, detaching the metal sheet 1 from the punching machine, and again cleaning the metal sheet 1, to remove impurities or oil spots on the surface of the metal sheet 1; next, placing the metal sheet 1 on an injection machine, and performing an injection molding of high polymer materials 2 for the hexagonal grooves 11 and the metal sheet surface by an inserted injection molding method. Once the injection molding is finished, performing plastic and distressing for the manufactured metal sheet 1.

In the embodiment, once the above manufacture is finished, perform spray-painting or prepare ermatoglyph on the side of the metal sheet having high polymer material of injection molding.

The metal sheet in the present invention has wide variety of forms, which may be galvanized metal sheet, common sheet plate, cold rolled metal sheet, or tin metal sheet, etc.

To sum up, the structure of metal sheet of autobody and its manufacturing method of the present invention enable to solve the problems that the metal sheet of autobody has overlarge mass and high cost. Therefore, the present invention effectively overcome some practical issues in the prior art, thereby having high utility value and usage significance.

The abovementioned embodiments only illustratively describe the principle and efficacy of the present invention, rather than being used to limit the present invention. Any person skilled in the art may modify or amend the abovementioned embodiments without departing from the spirit and scope of the present invention. Thus, all equivalent modifications or amendments accomplished by persons having common knowledge in the technical field concerned without departing from the spirit and technical thoughts revealed by the present invention shall still be covered by the claims of the present invention.

What is claimed is:

1. A structure of metal sheet of autobody, characterized in that, the metal sheet (1) is uniformly provided with a plurality of hexagonal grooves (11), in the hexagonal grooves (11) and on the side of metal sheet surface having the hexagonal grooves (11) are all provided with high polymer material (2).

2. The structure of metal sheet of autobody according to claim 1, characterized in that, depth of the hexagonal groove (11) is 0.5˜3 mm.

3. The structure of metal sheet of autobody according to claim 1, characterized in that, thickness of the high polymer material (2) of the metal sheet surface is 0.5˜3 mm.

4. The structure of metal sheet of autobody according to claim 1, characterized in that, distance between two opposite sides of the hexagonal groove (11) is 3˜25 mm.

5. The structure of metal sheet of autobody according to claim 1, characterized in that, one side of the metal sheet (1) having no high polymer material is provided with felt or other fillers featuring cushioning, soundproof, insulating effects.

6. The structure of metal sheet of autobody according to claim 1, characterized in that, the high polymer material (2) is PC material, PP-like material, improved PP-like material, ABS material, PMMA material or PBT material.

7. A manufacturing method for a structure of metal sheet of autobody, characterized in that, it comprises the following steps:
first, cleaning the metal sheet (1) to be manufactured, and removing impurities on a surface of the metal sheet (1);
second, placing the metal sheet (1) on a punching machine, and punching hexagonal grooves (11) on the metal sheet (1) by the punching machine;
third, detaching the metal sheet (1) from the punching machine, placing the metal sheet (1) on an injection machine, and performing an injection molding of high polymer material (2) for the hexagonal grooves (11) and the metal sheet surface by an inserted injection molding method.

8. The manufacturing method for a structure of metal sheet of autobody according to claim 7, characterized in that, after the third step, performing spray-painting or preparing dermatoglyph on the side of the metal sheet (1) having high polymer material of injection molding.
